(19) United States
(12) Patent Application Publication
(10) Pub. No.: US 2003/0202718 A1
(43) Pub. Date: Oct. 30, 2003

(54) Resealable package having slider device; and methods

(76) Inventor: Mladomir Tomic, Appleton, WI (US)

Correspondence Address: ALCOA INC, ALCOA TECHNICAL CENTER, 100 TECHNICAL DRIVE, ALCOA CENTER, PA, 15069-0001, US

(21) Appl. No.: 10/131,853

(22) Filed: Apr. 25, 2002

(51) Int. Cl. B65D 33/16; B31B 1/84

(52) U.S. Cl. 383/64; 493/213

(57) ABSTRACT

Flexible resealable packages include a resealable closure mechanism, and a slider device operably mounted on the resealable closure mechanism. The resealable closure mechanism includes first and second closure profiles extending from a first side edge to a second side edge. The first or second closure profile includes a slider guide channel and a guide protrusion stop. The slider device selectively opens and closes the closure mechanism. The slider device includes a top wall and first and second hook constructions depending from the top wall. The slider also includes a guide protrusion extending from first or second hook construction constructed and arranged to mate with the slider guide channel.

### FIELD OF THE INVENTION

This disclosure generally relates to resealable packages having slider devices, and methods for making and using. In particular, the disclosure relates to closure arrangements for resealable packages including particular types of engagements between slider devices and the closure arrangement.

### BACKGROUND OF THE INVENTION

Many packaging applications use resealable containers to store or enclose various types of articles and materials. These packages may be used to store food products, non-food consumer goods, medical supplies, waste materials, and many other articles. Resealable packages are convenient in that they can be closed and resealed after the initial opening to preserve the enclosed contents. The need to locate a storage container for the unused portion of the products in the package is thus avoided. In some instances, providing products in resealable packages appreciably enhances the marketability of those products.

Some types of resealable packages are opened and closed using a slider device. The slider device typically includes a separator or spreader-type structure at one end that opens a closure mechanism, the closure mechanism having profiled elements or closure profiles, when the slider device travels in a first direction along the mechanism. The sidewalls of the slider device are configured so that, close the resealable package, the sidewalls engage the closure profiles and progressively move the closure profiles into engagement to when the slider device is moved along the closure mechanism in a direction opposite the first direction.

Improvements in the design and manufacture of closure mechanisms and slider devices are desirable.

### SUMMARY OF THE INVENTION

The present disclosure is directed to resealable packages including a resealable closure mechanism and having a slider device for opening and closing the closure mechanism. The package includes a system for guiding the slider device between the side edges of the package and for preventing the slider device from sliding off the edge of the package. This slider guide system includes a guide protrusion on the slider, a slider guide channel within the closure mechanism for accepting the guide protrusion therein, and a guide protrusion stop at a side edge of the package. Preferably, the closure mechanism has two slider guide channels, and the slider has two guide protrusions. As stated, the guide protrusion mates with or is otherwise accepted into the slider guide channel. During movement of the slider device along the closure mechanism, the guide protrusion detects the guide protrusion stop before any other structure on the slider device engages the side edges of the package.

In operation, the guide protrusion will abut or engage the guide protrusion stop to inhibit the slider device from sliding off of the resealable package. Thus, the guide protrusion helps to keep the slider device within the boundaries or periphery defined by the side edges of the package.

In one embodiment, a package having a surrounding wall having first and second panel sections and a mouth there between, the mouth providing access to a package interior, is provided. The package further has a resealable closure mechanism along the mouth for selective opening and closing of the mouth, the closure mechanism extending from a first side edge to a second side edge of the package and including first and second closure profiles. The first and second closure profiles are constructed and arranged to interlock, and at least one of the first and second closure profiles includes a slider guide channel which has a crushed guide protrusion stop. The crushed guide protrusion stop is made by ultrasonically crushing, thermally crushing, or a combination thereof a portion of the closure profiles including the slider guide channel. The crushed guide protrusion stop is oriented along at least a portion of each of the first side edge and the second side edge. The package also has a slider device operably mounted on the resealable closure mechanism to selectively open and close the closure mechanism by sliding along the closure mechanism between the first side edge and the second side edge. The slider device has a housing including a top wall, a spreader depending from the top wall to separate the first and second closure profiles, a first hook construction depending from the top wall, a second hook construction depending from the top wall and in opposing relation to the first hook construction, and a guide protrusion extending from at least one of the first and second hook constructions in slidable engagement with the slider guide channel. The guide protrusion of the slider device abuts the crushed guide protrusion stop at the side edges when the slider device is moved between the side edges. The slider device also has a groove, defined by the first and second hook constructions and the top wall, which is in slidable receipt of the closure mechanism.

### BRIEF DESCRIPTION OF THE DRAWINGS

FIG. 1 is a perspective, schematic view of an embodiment of a flexible, resealable package having a slider device, constructed according to principles of this disclosure;

FIG. 2 is a cross-sectional view of the resealable package of FIG. 1, taken along line 2-2, including a schematic illustration of the slider device;

FIG. 3 is an enlarged, top perspective view of the slider device of FIG. 1;

FIG. 4 is an enlarged, bottom perspective view of the slider device of FIGS. 1 and 3;

FIG. 5 is a bottom plan view of the slider device of FIGS. 3 and 4;

FIG. 6 is a bottom plan view of the slider device of FIGS. 3 and 4;

FIG. 7 is a cross-sectional view of the slider device of FIG. 6 taken along the line 7-7 of FIG. 6;

FIG. 8 is a side elevation view of the slider device of FIG. 6;

FIG. 9 is an end elevation view of the slider device of FIGS. 6 and 7;

FIG. 10 is a partial cross-sectional view, similar to the view of the package of FIG. 2, of another embodiment of a slider device, according to principles of this disclosure;

FIG. 11 11 is a cross-sectional view, similar to the view of FIG. 10, of another embodiment of a slider device, according to principles of this disclosure;

FIG. 12 is a cross-sectional view, similar to the view of FIGS. 10 and 11, of another embodiment of a slider device, according to principles of this disclosure;

FIG. 13 is a bottom plan view of the slider device of FIG. 2 operably mounted on a resealable closure mechanism;

FIG. 14 14 is a bottom plan view of another embodiment of a slider device operably mounted on a resealable closure mechanism; and

FIG. 15 is a side elevation view of a side seal portion of the flexible, resealable package depicted in FIG. 1.

### DETAILED DESCRIPTION OF PREFERRED EMBODIMENTS

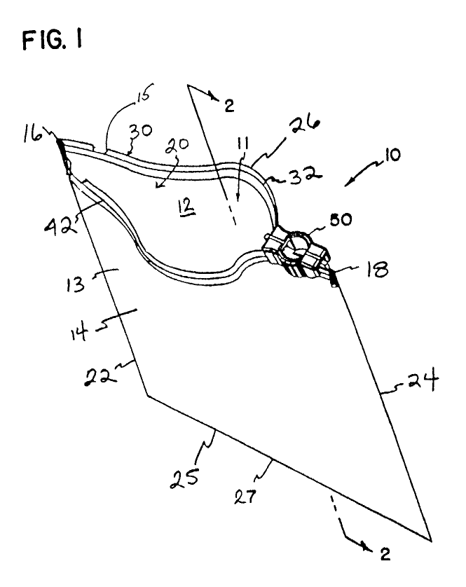

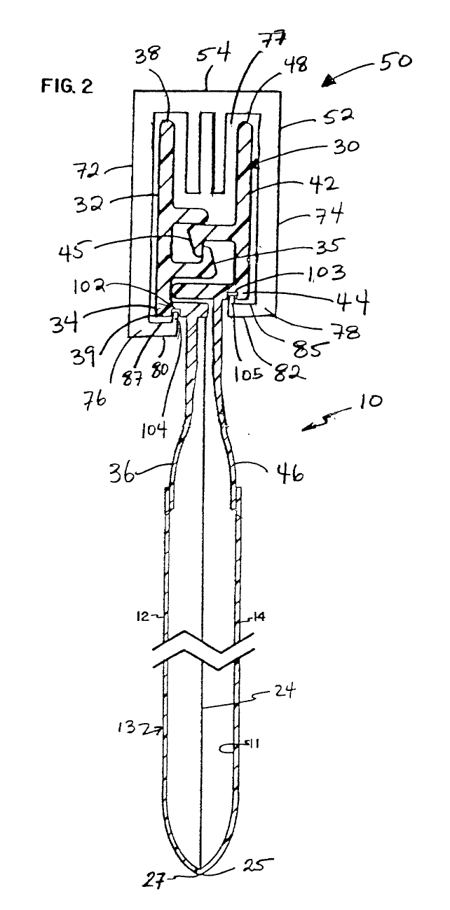

Attention is directed to FIGS. 1 and 2, which illustrate an example packaging arrangement in the form of a resealable, flexible package 10, for example, a polymeric package such as a plastic bag. Package 10 has a resealable closure mechanism 30, which includes interlocking profiled elements attached to package surrounding wall 13. A slider device 50 is mounted on closure mechanism 30 to facilitate selected opening and closing of closure mechanism 30.

Package surrounding wall 13 is typically made from a flexible, polymeric, plastic film, and includes first and second opposed panel sections 12, 14. With some manufacturing applications, first and second panel sections 12, 14 are heat-sealed together along two side edges 22, 24 and meet at a fold line 25 in order to form a three-edged containment section for a product within an interior 11 of package 10. In the embodiment shown, fold line 25 includes a bottom edge 27 of package 10. In another embodiment, first and second panel sections 12, 14 are folded at side edges 22, 24 and heat-sealed at bottom edge 27; such a package may include a fin seal (not shown) within one of panel sections 12, 14. In yet another embodiment, panel sections 12, 14 are folded at one side edge, for example, first side edge 22, and heat-sealed at second side edge 24 and at bottom edge 27. Alternatively, two separate panel sections 12, 14 of plastic film may be used and heat-sealed together along both side edges 22, 24 and at bottom edge 27. In some embodiments, bottom edge 27 of package 10 may be left open to allow filling of package 10 through bottom edge 27; bottom edge 27 is then sealed after product has been positioned within interior 11 of package 10.

Access is provided to interior 11 of package 10 through a mouth 20 at a top edge 26 of the package. Alternatively, mouth 20 could be positioned on package 10 at a location different from top edge 26 of package 10, depending on the application needs for package 10. In the particular embodiment shown in FIG. 1, mouth 20 extends the width of package 10, from first side edge 22 to second side edge 24. Resealable closure mechanism 30 is present at mouth 20 to allow sealing and unsealing of mouth 20. In the embodiment shown, resealable closure mechanism 30 extends the width of mouth 20 at top edge 26.

Resealable closure mechanism 30 can be one of a variety of closure mechanisms. In the particular embodiment illustrated in FIG. 2, resealable closure mechanism 30 is shown in the specific form of a zipper-type closure mechanism. By the term “zipper-type closure mechanism,” it is meant a structure having opposite interlocking or mating profiled elements that under the application of pressure will interlock and close the region between the profiles.

As stated above, closure mechanism 30 has interlocking profiled elements, such as first closure profile 32 and second closure profile 42 (FIGS. 1 and 2). First and second closure profiles 32, 42 engage and disengage with one another to allow selected opening and closing of closure mechanism 30.

As seen in FIG. 2, first closure profile 32 includes a base strip 34, a sealing flange or bonding strip 36, a first mating closure member 35, and an upper flange or distal end 38. Mating closure member 35 extends from base strip 34 and is generally projecting from base strip 34. Sealing flange 36 depends or extends downward from base strip 34 and is sealed or otherwise attached to a first panel section, such as first panel section 12 of package 10 shown in FIG. 2. A first shoulder 39 is defined by the intersection of base strip 34 and sealing flange 36; shoulder 39 is located at a corner of closure profile 32. First closure profile 32 further includes a slider guide channel 102, generally formed within and defined by a portion of closure profile 32, in this case base strip 34. In the embodiment shown in FIG. 2, channel 102 has a generally rectangular shape and is positioned between shoulder 39 and sealing flange 36.

Similarly, second closure profile 42 includes a base strip 44, a bonding strip or sealing flange 46, a second mating closure member 45, and an upper flange or distal end 48. Mating closure member 45 extends from base strip 44 and is generally projecting from base strip 44. Sealing flange 46 depends or extends downward from base strip 44 and is sealed or otherwise attached to a second panel section, such as second panel section 14 of package 10 shown in FIG. 2. A shoulder 49, analogous to shoulder 39, is formed at the corner of sealing flange 46 and base strip 44. Second closure profile 42 includes a slider guide channel 103, generally formed within and defined by a portion of closure profile 42, in this case base strip 44. In the embodiment shown in FIG. 2, channel 103 is positioned between shoulder 49 and sealing flange 46.

As mentioned, closure profiles 32, 42 engage and disengage with one another, in particular, mating closure members 35, 45 are designed to mate and engage with one another. To engage closure profiles 32, 42 and thus close or seal closure mechanism 30, pressure is applied to closure profiles 32, 42. Pulling closure profile 32 and closure profile 42 away from each other causes the two closure profiles 32, 42 to disengage, unsealing and opening closure mechanism 30.

Referring again to FIG. 1, closure mechanism 30 extends the width of package 10 from side edge 22 to side edge 24. Closure profiles 32, 42 are sealed together at their ends, such as at regions 16, 18 located at side edges 22, 24; this sealing aids in aligning closure profiles 32, 42 for interlocking. Regions 16, 18 are preferably formed by ultrasonic or thermal crushing, as explained further below.

The various features of closure profiles 32, 42 generally extend the length of closure mechanism 30, that is, from side edge 22 to edge 24 of package 10. It is understood that in some embodiments, a portion of either or both of closure profiles 32,42 may become distorted during processing of closure mechanism 30 or package 10. Particularly, in regions 16, 18 a portion of closure profiles 32, 42 is distorted, as will be explained below.

Typically, closure profiles 32, 42 are manufactured, typically extruded, separately. In other embodiments, the two closure profiles 32, 42 are manufactured as a single structure and then slit or otherwise separated. Closure mechanism 30 typically is made of conventional materials, such as a polymeric material, for example, polyethylene, polypropylene, or PVC.

Referring again to FIG. 1, a cutout or notch 15 is formed in upper flanges 38, 48 (FIG. 2) of closure mechanism 30. Notch 15 serves as a “parking place” for slider device 50 and also facilitates mounting slider device 50 onto package 10 during initial assembly. In addition, notch 15 helps create a stop member for slider device 50.

Mounted on closure mechanism 30, to facilitate sealing and unsealing closure profiles 32, 42, is slider device 50. Although shown schematically in FIG. 2, slider device 50 includes a housing 52 having a top wall 54, and first and second sidewalls 72, 74 extending from top wall 54. Together, top wall 54 and sidewalls 72, 74 define a slide groove or groove 77, for slidably receiving closure mechanism 30 therein. Slider device 50 has a first hook construction 76 and a second hook construction 78; specifically, first hook construction 76 extends from first sidewall 72, and second hook construction 78 extends from second sidewall 74. When slider device 50 is mounted on closure mechanism 30, closure mechanism 30 is positioned within slide groove 77, between first sidewall 72 and first hook construction 76 and second sidewall 74 and second hook construction 78.

In the embodiment shown, first hook construction 76 includes a hook base 80 in lateral extension from first sidewall 72. Hook base 80 has an engagement surface 87 on an interior surface of hook base 80. Extending or projecting in vertical extension from engagement surface 87 is a guide protrusion 104, which, in the embodiment shown, extends toward top wall 54. Guide protrusion 104, positioned extending from the portion of engagement surface 87 closest to sealing flange 36 of closure profile 32, is constructed and arranged to be accepted within slider guide channel 102 of closure profile 32. Guide protrusion 104 can be rectangular, trapezoidal, rhombic or any other shape, and is preferably complementary to slider guide channel 102. In the one shown in FIG. 2, guide protrusion is rectangular shaped. Guide protrusion 104 and slider guide channel 102 are shaped and sized to allow slider guide channel 102 to slidably accept guide protrusion 104 therein. Guide protrusion 104 and slider guide channel 102 mate, join, interlock, mesh, or otherwise slidably engage, and form a portion of a slider guide system, described below.

Guide protrusion 104 and hook base 80, particularly engagement surface 87, in combination with sidewall 72, form a hook or catch for slidable engagement with slider guide channel 102 and shoulder 39 of first closure profile 32, as seen in FIG. 2.

Analogously, second hook construction 78 includes a hook base 82 in extension from second sidewall 74. Hook base 82 includes an engagement surface 85 on an interior surface of hook base 82. Extending or projecting in vertical extension from engagement surface 85 is a guide protrusion 105, positioned extending from the portion of engagement surface 85 closest to sealing flange 46 of closure profile 42, and which is constructed and arranged to be accepted within slider guide channel 103 of closure profile 42. Guide protrusion 105 can be rectangular, trapezoidal, rhombic or any other shape and is preferably complementary with channel 103. Guide protrusion 105 and slider guide channel 103 are shaped and sized to allow slider guide channel 103 to slidably accept guide protrusion 105 therein. Guide protrusion 105 and slider guide channel 103 mate, join, interlock, mesh, or otherwise slidably engage, and form a portion of a slider guide system, described below.

Although guide protrusions 104, 105 are illustrated as having a fairly square or rectangular shape, guide protrusions 104, 105 can have any shape, such as square, rectangular, rounded, triangular (pointed), truncated point, barbed, and the like. Guide protrusion 104, 105 and slider guide channel 102, 103 may be the same or similar shapes, or may be different, so long as the shapes are complementary.

As seen in FIG. 2, first hook construction 76 is located closer to top wall 54 than second hook construction 78. This is generally because, in the embodiment shown, second sidewall 74 is longer than first sidewall 72. Additionally, guide protrusion 105 may be positioned closer to top wall 54 than guide protrusion 104. In some embodiments, however, it may be that first sidewall 72 is essentially the same length as second sidewall 74, thus providing guide protrusion 105 and engagement surface 85 essentially level with second guide protrusion 104 and engagement surface 87. The structure of hook constructions 76, 78 is generally dictated by the structure of first and second closure profiles 32, 42.

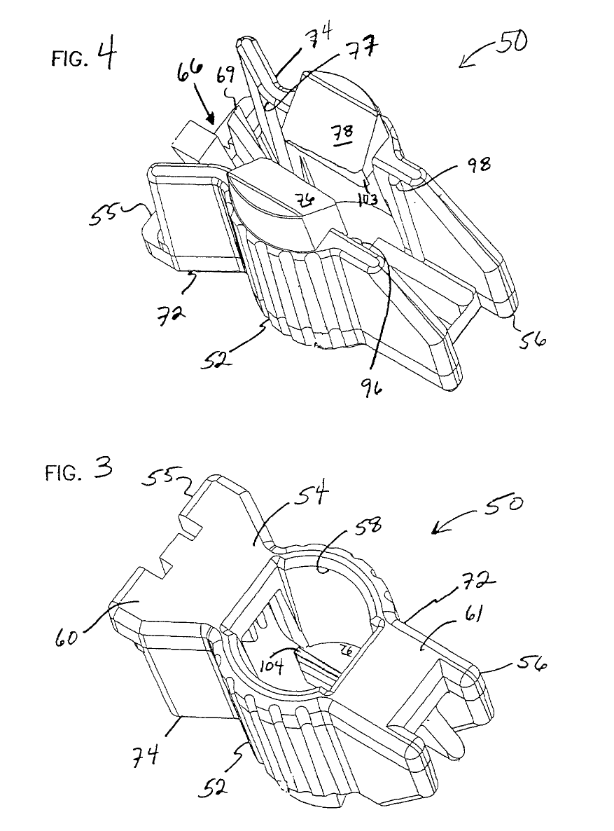

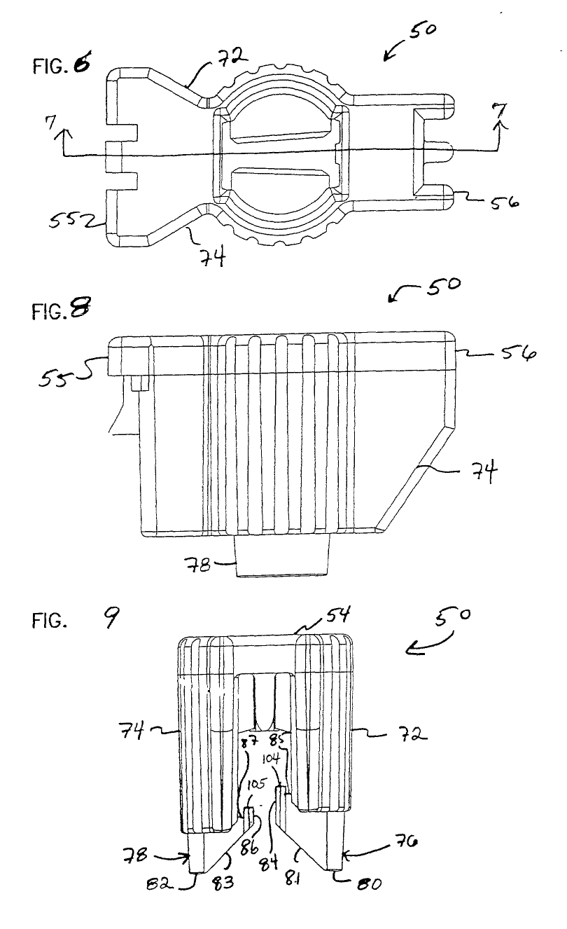

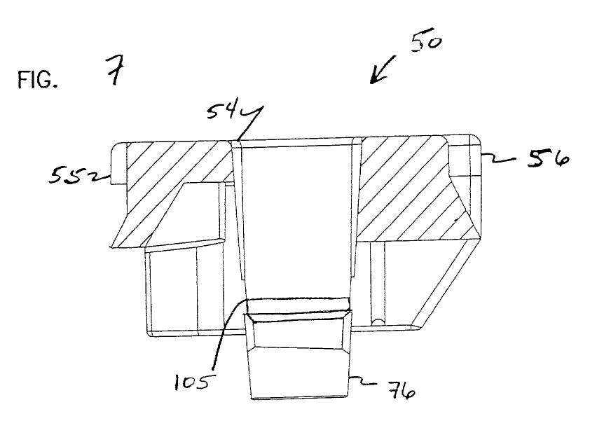

Although shown as generally positioned perpendicular to top wall 54 and extending away with a generally even width, sidewalls 72, 74 can be positioned at an angle other than 90 degree to top wall 54, or may taper down in thickness from top wall 54 to hook base 80, 82. The thickness of sidewalls may also be dictated by the structure of closure profiles 32, 42. Additional details regarding slider device 50 are provided with respect to FIGS. 3-9.

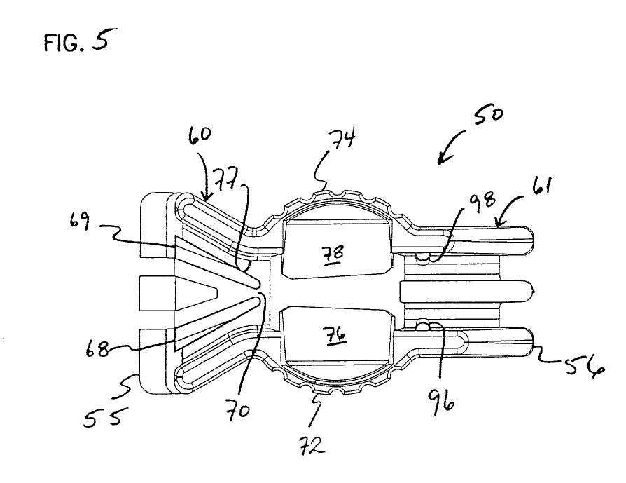

Referring to FIGS. 3 and 4, slider device 50 has a first end 55, an opposite second end 56, and an open aperture 58, which divides top wall 54 between a first portion 60 and a second portion 61. Slider device 50 further includes a separation structure for separating closure profiles 32, 42 when desired. That is, when closure mechanism 30 is in a closed state such that mating closure members 35, 45 are interlocked, the separation structure will apply a force to wedge open and pull closure members 35, 45 apart from each other. In the embodiment illustrated, housing 52 includes a spreader 66 operating as a separation structure. Spreader 66, in the embodiment shown, comprises first and second angled wedges 68, 69 separated by a gap 70 (FIG. 5) there between.

In FIG. 5, first and second wedges 68, 69 form an overall triangle shaped spreader 66, in plan view, with an apex of the triangle pointing toward second end 56 of slider device 50. Spreader 66 only generally extends partially into closure mechanism 30; that is, spreader 66 preferably extends between upper flanges 38, 48 and does not penetrate mating closure members 35, 45. Other constructions of spreader 66 are usable.

Slider device 50 further includes first and second drag reducing standoffs 96, 98, seen in FIGS. 4 and 5, which project from or extend from sidewalls 72, 74. In operation, standoffs 96, 98 slidably communicate with closure profiles 32, 42, respectively. Because of the projection and extension of standoffs 96, 98 relative to the remaining portions of housing 52, the amount of surface area contact or material inducing friction between housing 52 and closure mechanism 30 is minimized. This permits easier manipulation of slider device 50 by the user.

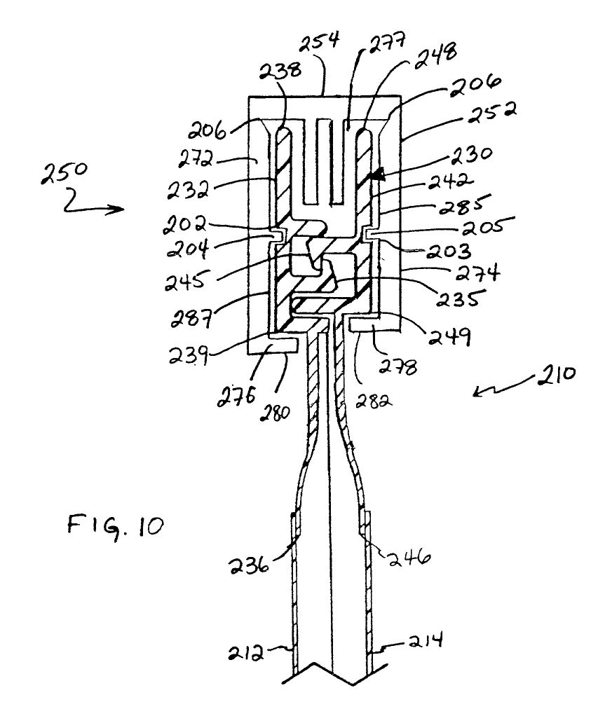

As best seen in FIG. 9, first hook construction 76 has hook base 80 in lateral extension from first sidewall 72. Extending or projecting from hook base 80 is a deflection surface 81. Deflection surface 81 is oriented toward top wall 54 as a sloped or tapered surface and terminates at tip 84. Protrusion guide 104 extends from engagement surface 85 at tip 84 toward top wall 54. Similarly, second hook construction 78 has hook base 82 in lateral extension from sidewall 74. Extending or projecting from hook base 82 is a deflection surface 83. Deflection surface 83 is oriented toward top wall 54 as a sloped or tapered surface and terminates at tip 86. Protrusion guide 105 extends from engagement surface 87 at tip 86 toward top wall 54. Deflection surfaces 81, 83 are oriented to have an angle in relation to top wall 54 of about 40 to 50 degrees, preferably about 45 degrees. This provides an angle between first and second deflection surfaces 81, 83 of about 80 to 100 degrees, or about 90 degrees.

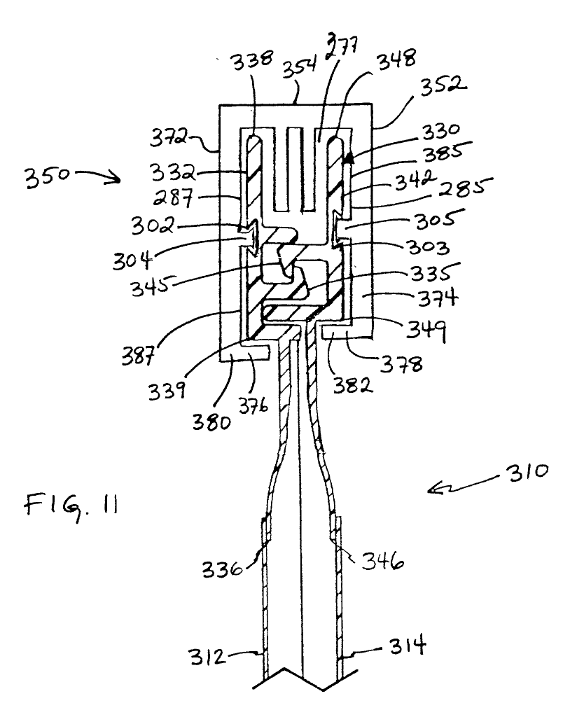

FIG. 10 is a cross-sectional view, similar to the view of FIG. 2, of another embodiment of a slider device 250 mounted on a resealable closure mechanism 230. In FIG. 10, only a portion the package, package 210 having panel sections 212, 214, is shown. Similar to the embodiment of FIG. 2, closure mechanism 230 has first and second closure profiles 232, 242 designed to engage with one another to form resealable closure mechanism 230. In so far as elements are the same as elements of the embodiment of FIG. 2, the same description and generally similar reference numerals, incremented by 200, are provided.

First closure profile 232 includes a base strip 234, a sealing flange 236, a first mating closure member 235, and an upper flange or distal end 238. Mating closure member 235 extends from base strip 234 and is generally projecting from base strip 234. Sealing flange 236 depends or extends downward from base strip 234 and is attached to first panel section 212. A first shoulder 239 is defined by the intersection of base strip 234 and sealing flange 236. Closure profile 232 includes a slider guide channel 202. Slider guide channel 202 is within base strip 234, positioned between distal end 238 and shoulder 239.

Second closure profile 242 includes a base strip 244, a sealing flange 246, a second mating closure member 245, and an upper flange or distal end 248. Mating closure member 245 extends from base strip 244 and is generally projecting from base strip 244. Sealing flange 246 depends or extends downward from base strip 244 and is attached to second panel section 214 of package 210. A shoulder 249 is formed at the corner of sealing flange 246 and base strip 244. Second closure profile 242 includes a slider guide channel 203. Slider guide channel 203 is within base strip 244, positioned between distal end 248 and shoulder 249.

FIG. 10 includes a slider device 250 operably mounted on closure mechanism 230. Slider device 250 is provided to close and open, mate and unmate, closure mechanism 230. Slider device 250 has a housing 252 that includes a top wall 254 and first and second sidewalls 272, 274 each extending from and cantilevered from top wall 254 to form a slide groove 277 therebetween. Slider device 250 further includes a flex point 206, which aids in placing slider device 250 on closure device 230, by requiring less force to spread sidewalls 272, 274 apart as slider device 250 is placed on closure mechanism 230.

As with the embodiment of FIG. 2, slider device 250 includes a system for permitting housing 252 to slide along closure mechanism 230 without becoming disengaged from package 210. In the embodiment illustrated, housing 252 engages or interlocks with a portion of closure mechanism 230; in particular, slider device 250 has a first and a second hook construction 276, 278 that engage with closure mechanism 230. First hook construction 276 extends from first sidewall 272, and second hook construction 278 extends from second sidewall 274. When slider device 250 is mounted on the resealable closure mechanism, closure mechanism 230 is positioned between first hook construction 276 and second hook construction 278.

First hook construction 276 includes a hook base 280 in lateral extension from first sidewall 272, which includes an engagement surface 287 on an interior surface of sidewall 272. Extending or projecting in horizontal extension from engagement surface 287 is a guide protrusion 204 that extends toward the second sidewall 274. Guide protrusion 204 is constructed and arranged to be accepted within slider guide channel 202 of closure profile 232 and optionally mate with the slider protrusion channel 202. Guide protrusion 204 can have a rectangular, trapezoidal, rhombic or any other shape extending from engagement surface 287. In this embodiment, guide protrusion 204 is generally rectangular. Guide protrusion 204 and hook base 280, in combination with sidewall 272, form a hook or catch for slidable engagement with slider guide channel 202 and shoulder 239 of closure profile 232, as seen in FIG. 10.

Analogously, second hook construction 278 includes a hook base 282 in extension from second sidewall 274. Sidewall 274 includes an engagement surface 285 on an interior surface of the sidewall 274. Extending or projecting in horizontal extension from engagement surface 285 is a guide protrusion 205, which is constructed and arranged to be accepted in, and optionally mate with, slider guide channel 203. Guide protrusion 205 can have a rectangular, trapezoidal, rhombic or any other shape extending from engagement surface 285. In this embodiment, guide protrusion 204 is generally rectangular. Guide protrusion 205 and hook base 282, in combination with second side wall 274, form a hook or catch for slidable engagement with slider guide channel 203 and shoulder 249 of the second closure profile 242.

Although guide protrusions 204, 205 are illustrated as having a fairly square or rectangular shape, as stated above in reference to the embodiment of FIG. 2, guide protrusions 204, 205 can have any shape, such as square, rectangular, rounded, triangular (pointed), truncated point, barbed, and the like. The shape of slider guide channel 202, 203 corresponds to or otherwise is complementary to guide protrusion 204, 205, optionally mating with slider guide channel 202, 203. Slider guide channels 202, 203 and guide protrusions 204, 205 are part of a slider guide system, described below.

Another embodiment of a slider device operably mounted on a resealable closure mechanism is shown in FIG. 11, which is a cross-sectional view of a partial package, similar to the view of FIG. 10. In so far as elements are the same as elements of the embodiment of FIG. 10, the same description and generally similar reference numerals, incremented by 100, are provided.

Package 310 with panel sections 312, 314 has a resealable closure mechanism 330 having engageable closure profiles 332, 342 with a slider device 350 operably mounted thereon.

Similar to FIG. 10, first closure profile 332 includes a base strip 334, a sealing flange or bonding strip 336, a first mating closure member 335, an upper flange or distal end 338, and a first shoulder 339, all which are configured in the same manner as in FIG. 10. First closure profile 332 includes a slider guide channel 302 that is present in base strip 334 between distal end 338 and shoulder 339. Second closure profile 342 also includes a base strip 344, a bonding strip or sealing flange 346, a second mating closure member 345, an upper flange or distal end 348, a shoulder 349, and a slider guide channel 303.

A slider device 350 operably mounted on closure mechanism 330 is provided to open and close, mate and unmate, closure mechanism 330. Slider device 350 has housing 352 defining a top wall 354, sidewalls 372, 374 and a groove 377 there between. Slider device 350 has hook constructions 376, 378 that engage with closure mechanism 330.

Hook constructions 376,378 include hook base 380,382 in lateral extension from sidewalls 372,374. Sidewalls 372,374 include engagement surfaces 387, 385 on an interior surface of sidewalls 372, 374. Extending or projecting in horizontal extension from engagement surface 387, 385 are guide protrusions 304, 305 which extend into groove 377 toward the opposite sidewall. In this embodiment, guide protrusions 304, 305 have a barbed shaped and are constructed and arranged to mate with slider guide channel 302, 303. Slider guide channels 302, 303 and guide protrusions 304, 305 form part of a slider guide system. Guide protrusions 304, 305 and hook bases 380, 382 in combination with sidewall 372, 374, form a hook or catch for slidable engagement with slider guide channel 302, 303 and shoulders 339, 349 of closure profiles 332, 342 as seen in FIG. 11.

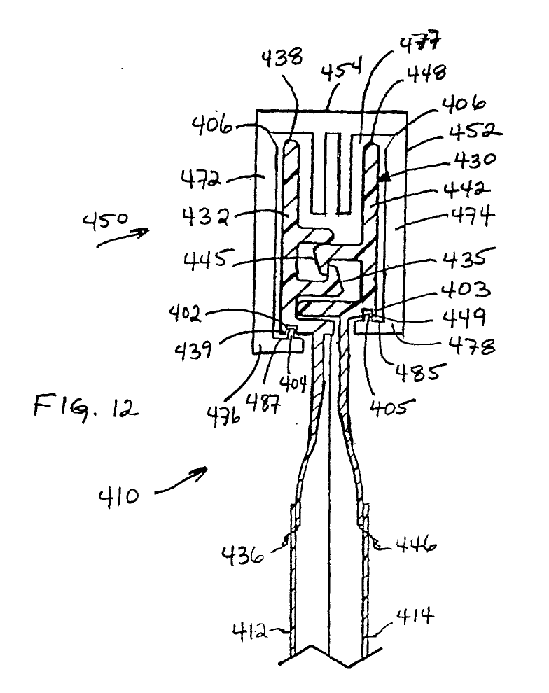

Yet another embodiment of a slider device operably mounted on a resealable closure mechanism is shown in FIG. 12, which is a cross-sectional view of a partial package, similar to the views of FIGS. 10 and 11. In so far as elements are the same as elements of the embodiments of FIGS. 10 and 11, the same description and generally similar reference numerals, incremented by 100, are provided.

Package 410 of FIG. 12 has panel sections 412, 414, reclosable closure mechanism 430 having a slider device 450 operably mounted thereon. Closure mechanism 430 has closure profiles 432, 442 each including a base strip 434, 444, a sealing flange 436, 446, a mating closure member 435, 445, an upper flange or distal end 438, 448, a shoulder 439, 449, and a slider guide channel 402, 403. Slider guide channel 402, 403 is formed between shoulder 439, 449 and sealing flange 436, 446.

A slider device 450 operably mounted on closure mechanism 430 has housing 452 defining a top wall 454, sidewalls 472, 474 and a groove 477 there between. Between top wall 452 and sidewalls 472, 474 is flex point 406, which aids in placing slider device 450 on closure mechanism 430 by requiring less force to spread sidewalls 472, 474 as the slider device is placed on closure mechanism 430. Slider device 450 has hook constructions 476, 478 having engagement surfaces 487, 485. Extending or projecting in vertical extension from engagement surface 487, 485 are rectangular guide protrusions 404, 405 which extend into groove 477 toward top wall 454. Guide protrusions 404, 405 are distanced from the end of hook construction 476, 478, that is, they are not positioned at the end of hook construction 476, 478, and are constructed and arranged to be accepted into and optionally mate with slider guide channel 402, 403 of closure profile 430. Guide protrusions 404, 405, in combination with sidewall 472, 474, form a hook or catch for slidable engagement with slider guide channel 402, 403 and shoulders 439, 449 of closure profiles 432, 442.

It is understood that guide protrusions 104, 105 (FIGS. 2 and 9), 204, 205 (FIG. 10), 304, 305 (FIG. 11), and 404, 405 (FIG. 12) can have any shape, such as described above, and the slider guide channels 102, 103 (FIG. 2), 202, 203 (FIG. 10), 302, 303 (FIG. 11), and 402, 403 (FIG. 12) are shaped and sized to accept the guide protrusion therein and provide slidable engagement.

Slider Guide System

The packages according to the present disclosure include a system for guiding the slider device between side edges 22, 24 (FIG. 1) and for preventing the slider device from sliding off the edge of the package. As illustrated in the various embodiments above, the slider guide system includes a guide protrusion on the slider device that is configured to be accepted into a slider protrusion or guide channel; for example, guide protrusions 104, 105 (FIGS. 2 and 9), 204, 205 (FIG. 10), 304, 305 (FIG. 11), and 404, 405 (FIG. 12), and slider guide channels 102, 103 (FIG. 2), 202, 203 (FIG. 10), 302, 303 (FIG. 11), and 402, 403 (FIG. 12). The system, and thus the package, further includes a guide protrusion stop.

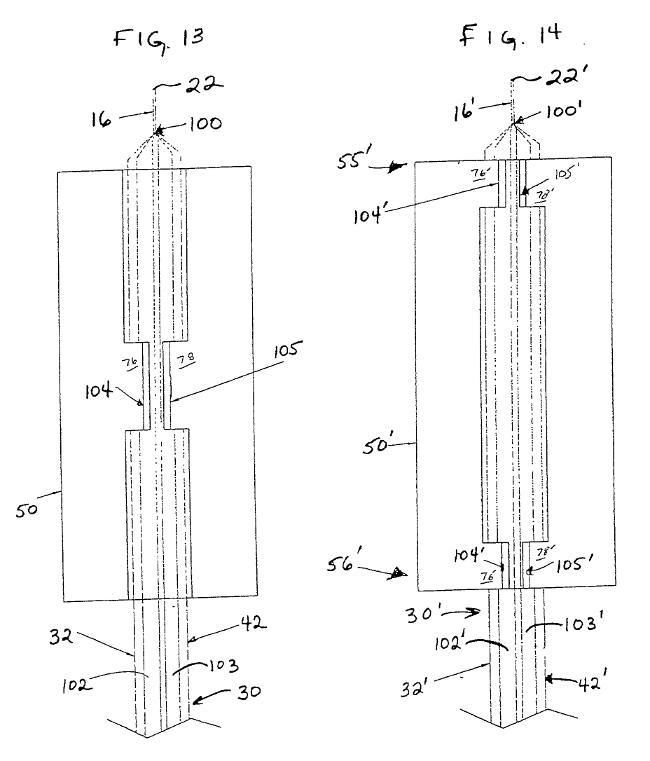

Referring now to FIGS. 13 and 15, a guide protrusion stop 100 is illustrated. Slider protrusion stop 100 is a region of material located in close proximity to one of side edge 22, 24, side edge 22 being shown in FIGS. 13 and 15. In most embodiments, guide protrusion stop 100 will be located in close proximity to each of side edges 22, 24. Preferably, slider protrusion stop 100 is adjacent to or integral with region 16, 18 which was discussed above as a crushed region. Slider protrusion stop 100 may be formed simultaneously with, and integral with, regions 16, 18. Alternately, slider protrusion stop 100 may be formed prior to or subsequent to forming region 16, 18. As stated above, regions 16, 18 can be ultrasonically or thermally crushed forming side seals.

Guide protrusion stop 100 is a region of crushed closure mechanism 30. A portion of one or both of closure profiles 32, 42 is crushed by the application of ultrasonic energy, thermal energy, or the combination, typically together with pressure, to form guide protrusion stop 100. The portion of closure profile 32, 42 crushed can be any one or combination of base strip 34, 44, sealing flange 36, 46, mating closure member 35, 45, distal end 38, 48, and slider guide channel 102, 103. In most embodiments, slider guide channel 102, 103 is at least partially distorted by crushing to the extent that guide protrusion 104, 105 does not engage therein.

FIG. 15 illustrates a side plan view of a portion of package 10. Package 10 has closure mechanism 30 (showing closure profile 32 with slider guide channel 102) attached to panel section 12 via sealing flange 36 and defining top edge 26 and side edge 22. At side edge 22 is crushed region 16. Proximate to region 16 is slider protrusion stop 100. In FIG. 15, slider protrusion stop 100 is contiguous with region 16, although slider protrusion stop 100 could be spaced from region 16. Slider protrusion stop 100 intersects slider guide channel 102.

Referring again to FIG. 13, a bottom plan view, slider device 50 is shown operably mounted on closure mechanism 30, specifically, on closure profiles 32, 42. Closure profiles 32, 42 have slider guide channels 102, 103 extending therein. As stated above, slider guide channel 102, 103 may extend the length of closure profiles 32 42, from side edge 22 to side edge 24 of package 10, or more accurately, from region 16 to region 18. Guide protrusions 104, 105 on hook constructions 76, 78 of slider device 50 are inserted, mated, accepted in, or otherwise present within slider guide channels 102, 103. Although two slider guide channels 102, 103 and two guide protrusions 104, 105, which engage with each other, are shown, it is contemplated that only one slider guide channel 102, 103 or only one guide protrusion 104, 105 might be present or mate with the corresponding feature.

In operation, guide protrusion 104, 105 mates with or is otherwise accepted into slider guide channel 102,103. As slider 50 is moved toward side edge 22 along the closure mechanism, guide protrusion 104, 105 abuts or engages guide protrusion stop 100 to inhibit slider device 50 from sliding off of closure profiles 32, 42 and the package. Thus, guide protrusion 104, 105 helps retain slider device 50 within the boundaries or periphery defined by side edges 22, 24.

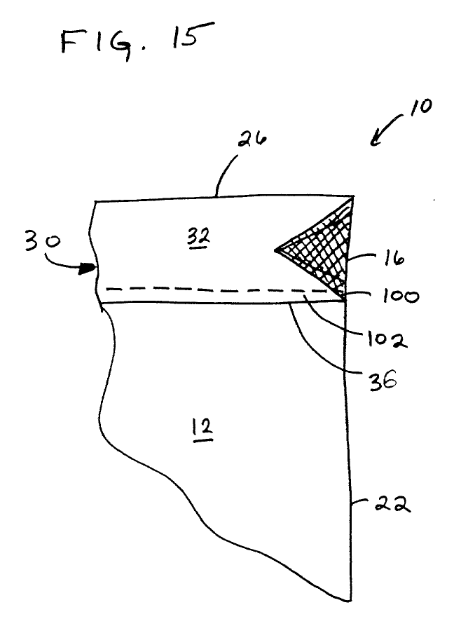

FIG. 14 is a bottom plan view of another embodiment of a slider device 50′ operably mounted on a resealable closure mechanism 30′. Slider device 50′ has a first end 55′ and an opposite second end 56′, and includes a first hook construction 76′ and a second hook construction 78′ located near each end 55′, 56′. Slider device 50′ includes guide protrusion 104′, 105′. Closure mechanism 30′ has closure profiles 32′, 42′, having slider guide channels 102′, 103′ extending therein, extend to crush region 16′ at side edge 22′. A guide protrusion stop 100′, similar to guide protrusion stop 100 of FIGS. 13 and 15, is located at crush region 16′.

Manufacturing a Resealable Package

The following method can be used to construct a flexible resealable package having the system of the present disclosure for guiding the slider device between package side edges and for preventing the slider device from sliding off the edge of the package.

Package 10 can be formed by either a blown extrusion process or by using a pre-formed roll of film, as has been described above in the general discussion of package 10 with respect to FIGS. 1 and 2. Various other manufacturing techniques can be used to provide package 10. Closure mechanism 30 can be applied to panel sections 12, 14 by heat sealing sealing flanges 36, 46 of closure profiles 32, 42 to the panel sections 12, 14. Notch 15 can be cut, punched, or otherwise formed in upper flanges or distal ends 38, 48 of closure profiles 32, 42.

Side seals 22, 24 and guide protrusion stop 100 including regions 16, 18 can be formed by methods such as ultrasonic crushing, thermal crushing, or a combination thereof Slider device 50 can then be mounted on closure mechanism 30 by sliding it over distal ends 38, 48 and engaging hook constructions 76, 78 with shoulders 39, 49 so that closure profiles 32, 42 are positioned in slide groove 77 and guide protrusion 104, 105 mates with the slider guide channel 102, 103.

Various techniques for mounting slider device 50 onto closure mechanism 30 are available. Example methods are taught in U.S. patent application Ser. Nos. 09/611,167, 09/611,174, and 09/611,236 all filed Jul. 6, 2000; U.S. patent application Ser. No. 09/363,626 filed Jul. 29, 1999; and U.S. patent application Ser. No. 09/351,830 filed Jul. 12, 1999, each of which is incorporated herein by reference. Slider device 50 can be mounted by a horizontal, vertical, or angled mounting or application process. The mounting of slider device 50, whether accomplished by these example techniques or others, can be accomplished mechanically, pneumatically, or manually.

As described above, slider device 50 is positioned onto closure mechanism 30 over distal ends 38, 48 so that distal ends 38, 48 abut deflections surfaces 81, 83. As distal ends 38, 48 are forced against surfaces 81, 83, hook constructions 76, 78 deform or deflect outwardly until the tips 84, 86 (FIG. 9) snap over the shoulders 39, 49 of closure profiles 32, 42 and guide protrusion 104, 105 mates with slider guide channel 102, 103. Hook constructions 76, 78 are sufficiently flexible to facilitate mounting of the slider device 50, yet sufficiently stiff to retain slider device 50 onto closure mechanism 30.

It is understood that the process of forming the package, including mounting slider device 50 onto the closure mechanism 30 after the closure mechanism 30 is adhered to panel sections 12, 14, forming regions 16, 18, forming notch 15, and the like, can be done in any sequence of steps; in some embodiments, multiple steps can be done simultaneously. Additionally, in some embodiments it may be desired to have the package filled with items prior to mounting slider device 50.

Use of a Package

To operate the mounted slider device 50 and gain access to interior 11 of package 10, slider device 50 is slid relative to closure mechanism 30 from a closed position at first side edge 22 to an open position at second side edge 24. As slider device 50 is moved from the closed position to the open position, spreader 66 forces the mated closure members 35, 45 apart from each other. Spreader 66, positioned between the upper flanges or distal ends 38, 48 of closure profiles 32, 42, unmates closure profiles 32, 42 as the slider housing 52 is moved along the resealable closure mechanism 30 of package 10 in the direction toward where the triangle of spreader 66 “points.” The opening happens because the triangular shape of spreader 66 operates as a cam to force closure profiles 32, 42 apart, and thus to disengage the interlocking closure members 35, 45. To close closure mechanism 30, slider device 50 is moved relative to the resealable closure mechanism 30 from the open position to the closed position. The closing happens because slide groove 77 between sidewalls 72, 74 is narrower at second end 56 (the end away or remote from spreader 66) and is wider at first end 55 (the end near or adjacent to spreader 66). Note that no extra tools are needed for operation.

The above specification and examples are believed to provide a complete description of the manufacture and use of particular embodiments of the invention. Many embodiments of the invention can be made without departing from the spirit and scope of the invention.

Having described the presently preferred embodiments, it is to be understood that the invention may be otherwise embodied within the scope of the appended claims.

What is claimed is:

1. A flexible package comprising:
(a) a package surrounding wall having first and second panel sections and a mouth there between; said mouth providing access to a package interior;
(b) a resealable closure mechanism along said mouth for selective opening and closing of said mouth; said closure mechanism extending from a first side edge to a second side edge and including first and second closure profiles;
(i) at least one of said first and second closure profiles including a slider guide channel;
(ii) said first and second closure profiles being constructed and arranged to interlock;
(iii) said slider guide channel including a crushed guide protrusion stop, the crushed guide protrusion stop having been formed by at least one of ultrasonic crushing and thermal crushing;
(A) said crushed guide protrusion stop being oriented along at least a portion of each of said first side edge and said second side edge;
(c) a slider device operably mounted on said resealable closure mechanism to selectively open and close said closure mechanism by sliding along said closure mechanism between said first side edge and said second side edge; said slider device having a housing including:
(i) a top wall;
(ii) a spreader depending from said top wall to separate said first and second closure profiles;
(iii) a first hook construction depending from said top wall;
(iv) a second hook construction depending from said top wall and in opposing relation to said first hook construction;
(v) a guide protrusion extending from at least one of said first and second hook constructions in slidable engagement with said slider guide channel;
(A) said guide protrusion abutting said crushed guide protrusion stop at said first side edge and said second side edge when the slider device is moved between said first side edge and said second side edge; and
(vi) a groove defined by said first and second hook constructions and said top wall in slidable receipt of said closure mechanism.

2. A flexible package according to claim 1 wherein:
(a) said guide protrusion includes a first guide protrusion extending from said first hook construction and a second guide protrusion extending from said second hook construction; and
(b) said slider guide channel includes a first slider guide channel defined by said first closure profile and a second slider guide channel defined by said second closure profile.

3. A flexible package according to claim 2 wherein:
(a) said first closure profile includes an upper flange; a sealing flange secured to the package surrounding wall; a closure member extending from the upper flange; and a corner shoulder between the upper flange and the sealing flange;
(i) the first slider guide channel being defined by the corner shoulder;
(b) said second closure profile includes an upper flange; a sealing flange secured to the package surrounding wall; a closure member extending from the second closure profile upper flange; and a corner shoulder between the second closure profile upper flange and the second closure profile sealing flange;
(i) the second slider guide channel being defined by the second closure profile corner shoulder;
(c) said first hook construction comprises:
(i) a first end in opposing relation to said top wall;
(A) said first end including an engagement surface in slidable engagement with said first closure profile;
(B) said first guide protrusion extending from said first engagement surface and slidably mating with said first slider guide channel;
(d) said second hook construction comprises:
(i) a second end in opposing relation to said top wall;
(A) said second end including an engagement surface in slidable engagement with said second closure profile; and
(B) said second guide protrusion extending from said second end engagement surface and slidably mating with said second slider guide channel.

4. A flexible package according to claim 3 wherein:
(a) said first end engagement surface includes a distal end;
(i) said first guide protrusion extending from said distal end in a direction toward said top wall; and
(b) said second end engagement surface includes a distal end;
(i) said second guide protrusion extending from the distal end of said second end engagement surface in a direction toward said top wall.

5. A flexible package according to claim 3 wherein:
(a) said first end engagement surface includes a distal end;
(i) said first guide protrusion extending from said first end engagement surface spaced from said distal end and in a direction toward said top wall; and
(b) said second end engagement surface includes a distal end;
(i) said second guide protrusion extending from said second end engagement surface spaced from the distal end of said second end engagement surface and in a direction toward said top wall.

6. A flexible package according to claim 2 wherein:
(a) said first closure profile includes an upper flange; a sealing flange secured to the package surrounding wall; a closure member extending from the upper flange; and a corner shoulder between the upper flange and the sealing flange;
(i) the first slider guide channel being defined by the upper flange;
(b) said second closure profile includes an upper flange; a sealing flange secured to the package surrounding wall; a closure member extending from the second closure profile upper flange; and a corner shoulder between the second closure profile upper flange and the second closure profile sealing flange;
(i) the second slider guide channel being defined by the second closure profile upper flange;
(c) said first hook construction comprises:
(i) a first end in opposing relation to said top wall;
(ii) a first sidewall between said top wall and said first end;
(A) said first sidewall having a first engagement surface in slidable engagement with said first closure profile;
(B) said first guide protrusion extending from said first engagement surface and slidably mating with said first slider guide channel;
(d) said second hook construction comprises:
(i) a second end in opposing relation to said top wall;
(ii) a second sidewall between said top wall and said second end;
(A) said second sidewall having a second engagement surface in slidable engagement with said second closure profile;
(B) said second guide protrusion extending from said second engagement surface and slidably mating with said second slider guide channel.

7. A flexible package according to claim 6 wherein:
(a) each of said first and second guide protrusions has a rectangular cross-sectional shape.

8. A flexible package according to claim 6 wherein:
(a) each of said first and second guide protrusions has a trapezoidal cross-sectional shape.

9. A method of manufacturing a flexible package; the method comprising:
(a) providing first and second panel sections and a resealable closure mechanism secured thereto; the resealable closure mechanism including first and second interlocking closure profiles; each of the first and second interlocking closure profiles comprising a mating closure member, an upper flange, and a slider guide channel;
(b) providing a slider device comprising a top wall and first and second hook constructions projecting from the top wall; each of the first and second hook constructions including a guide protrusion positioned on an internal surface of the hook construction, the first and second hook constructions defining a groove there between;
(c) contacting the upper flanges of the closure profiles against the slider device;
(d) urging the closure profiles between the first and second hook constructions into the groove until the guide protrusion is received within the slider guide channel; and
(e) simultaneously sealing the first and second panel sections together and forming a first guide protrusion stop at a first side edge of the resealable closure mechanism by deforming the slider guide channel.

10. A method according to claim 9 further including:
(a) simultaneously sealing the first and second panel sections together and forming a second guide protrusion stop at a second side edge of the resealable closure mechanism by deforming the slider guide channel.

11. A method according to claim 10 wherein:
(a) said step of simultaneously sealing the first and second panel sections together and forming a first guide protrusion stop at a first side edge includes at least one of ultrasonically crushing and thermally crushing the slider guide channel to form the first guide protrusion stop at the first side edge of the resealable closure mechanism; and
(b) said step of simultaneously sealing the first and second panel sections together and forming a second guide protrusion stop at a second side edge includes at least one of ultrasonically crushing and thermally crushing the slider guide channel to form the second guide protrusion stop at the second side edge of the resealable closure mechanism.

12. A method according to claim 11 wherein:
(a) said step of providing first and second panel sections and a resealable closure mechanism secured thereto includes providing the resealable closure mechanism to have a slider guide channel defining a rectangular cross-sectional shape.

13. A method according to claim 11 wherein:
(a) said step of providing first and second panel sections and a resealable closure mechanism secured thereto includes providing the resealable closure mechanism to have a slider guide channel defining a trapezoidal cross-sectional shape.

14. A method of using a bag having a resealable closure mechanism and a slider device operably mounted thereon; the resealable closure mechanism including first and second interlocking closure profiles; the slider device comprising a top wall and first and second hook constructions projecting from the top wall; the method comprising:
(a) urging the slider device along the closure mechanism in a first direction to separate the first and second interlocking closure profiles;
(b) while urging the slider device along the closure mechanism in the first direction, sliding a protrusion extending from the slider device within a slider guide channel defined by the closure mechanism to hold the slider device onto the closure mechanism; and
(c) abutting the protrusion in the slider device against a first slider guide channel stop formed by a first deformation of the slider guide channel at a first side edge of the bag to prevent the slider device from sliding off the first side edge of the bag.

15. A method of using a bag according to claim 14 wherein:
(a) said step of sliding a protrusion includes sliding a protrusion extending from the slider device within a slider guide channel having a rectangular cross-section defined by the closure mechanism to hold the slider device onto the closure mechanism.

16. A method of using a bag according to claim 14 wherein:
(a) the slider device includes a top wall; a spreader depending from the top wall to separate the first and second closure profiles; a first hook construction depending from the top wall; a second hook construction depending from the top wall and in opposing relation to the first hook construction; a first guide protrusion extending from the first hook construction and a second guide protrusion extending from the second hook construction; and
(b) said step of sliding a protrusion includes sliding the first guide protrusion within a first slider guide channel defined by the closure mechanism and sliding the second guide protrusion within a second guide channel defined by the closure mechanism.

17. A method of using a bag according to claim 14 further including:
(a) urging the slider device along the closure mechanism in a second direction opposite to the first direction to mate the first and second interlocking closure profiles;
(b) while urging the slider device along the closure mechanism in the second direction, sliding the protrusion extending from the slider device within the slider guide channel defined by the closure mechanism to hold the slider device onto the closure mechanism; and
(c) abutting the protrusion in the slider device against a second slider guide channel stop formed by a second deformation of the slider guide channel at a second side edge of the bag to prevent the slider device from sliding off the second side edge of the bag.
